(19) United States
(12) Patent Application Publication
(10) Pub. No.: US 2026/0351898 A1
(43) Pub. Date: Nov. 5, 2026

(54) COUPLER BODY WITH INTEGRATED FLUX CONCENTRATORS

(71) Applicant: Rivian IP Holdings, LLC, Irvine, CA (US)

(72) Inventors: Seunghoon JEONG, La Mirada, CA (US); Young DOO, La Palma, CA (US); Thomas Hahn KIM, Granada Hills, CA (US)

(21) Appl. No.: 19/540,308

(22) Filed: Feb. 13, 2026

Related U.S. Application Data
(60) Provisional application No. 63/799,284, filed on May 2, 2025.

(51) Int. Cl. H01R 13/629; H01R 13/502; H01R 13/6581; H02M 7/48

(52) U.S. Cl. CPC H01R 13/629; H01R 13/502; H01R 13/62922; H01R 13/6581; H02M 7/48

(57) ABSTRACT

An apparatus includes a plurality of conductors each having an input terminal and an output terminal. The apparatus includes a plurality of flux concentrators each having one conductor of the plurality of conductors passing therethrough and defining a gap. A coupler body is molded over the plurality of conductors and the plurality of flux concentrators leaving the input terminal and the output terminal of each conductor of the plurality of conductors exposed. The coupler body defining a plurality of cavities, each cavity extending into the gap of a flux concentrator of the plurality of flux concentrators for receiving a Hall effect sensor of a plurality of Hall effect sensors.

### CROSS-REFERENCE TO RELATED APPLICATIONS

This application claims priority to and benefit of U.S. Provisional Patent Application No. 63/799,284, filed May 2, 2025, which is incorporated by reference herein in its entirety, and is hereby expressly made a part of this specification.

### INTRODUCTION

The present disclosure relates to an approach for implementing a flux concentrator for use with a Hall effect sensor.

### SUMMARY

The present disclosure describes an approach for implementing flux concentrators for use with Hall effect sensors. In one aspect, an apparatus includes a plurality of conductors each having an input terminal and an output terminal. The apparatus includes a plurality of flux concentrators each having one conductor of the plurality of conductors passing therethrough and defining a gap. A coupler body is molded over the plurality of conductors and the plurality of flux concentrators leaving the input terminal and the output terminal of each conductor of the plurality of conductors exposed, the coupler body defining a plurality of cavities, each cavity extending into the gap of a flux concentrator of the plurality of flux concentrators for receiving a Hall effect sensor of a plurality of Hall effect sensors.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating power electronics of a vehicle in accordance with certain embodiments.

FIGS. 4A and 4B are isometric views of a traction inverter system housing containing power electronics in accordance with certain embodiments.

FIGS. 5A and 5B are isometric views of a coupler body with integrated flux concentrators in accordance with certain embodiments.

FIG. 6 is a cross-sectional view of a coupler body with integrated flux concentrators in accordance with certain embodiments.

FIG. 7A is a top view of a circuit board with Hall effect sensors mounted to a coupler body with integrated flux concentrators in accordance with certain embodiments.

FIG. 7B is a cross-sectional view illustrating Hall effect sensors inserted in the flux concentrators of the coupler body in accordance with certain embodiments.

### DETAILED DESCRIPTION

Current output by a traction inverter system may be measured using Hall effect sensors, which require the use of flux concentrators to concentrate magnetic fields resulting from current flow onto the Hall effect sensors. Manufacturability of a traction inverter system is improved by embedding the flux concentrators in a coupler body that mounts output terminals to the housing of the traction inverter system. Conductors forming the output terminals and the input terminals of the coupler body pass through the flux concentrators. The coupler body defines cavities extending into gaps defined by the flux concentrators. A circuit board implementing power electronics (e.g., inverter switches) of the traction inverter system has Hall effect sensors mounted thereon that insert within the cavities upon assembly. Alignment features on the coupler body may engage alignment features on the circuit board to facilitate alignment of the Hall effect sensors with the cavities.

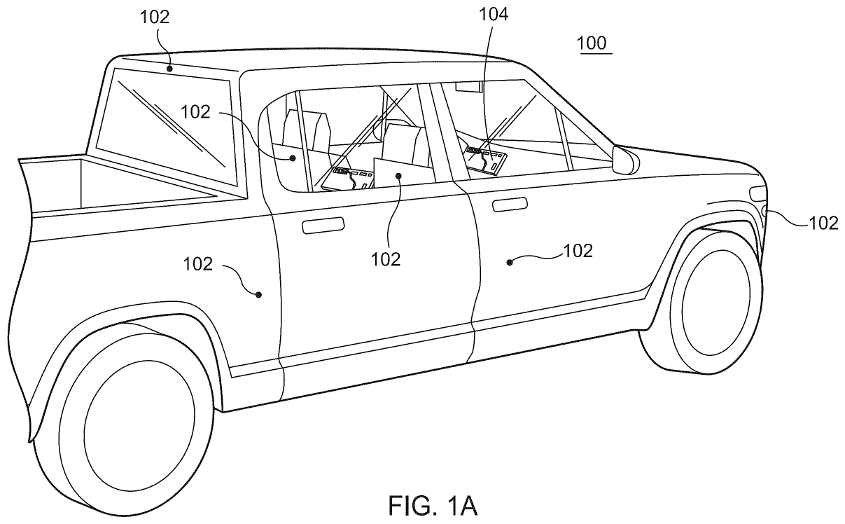

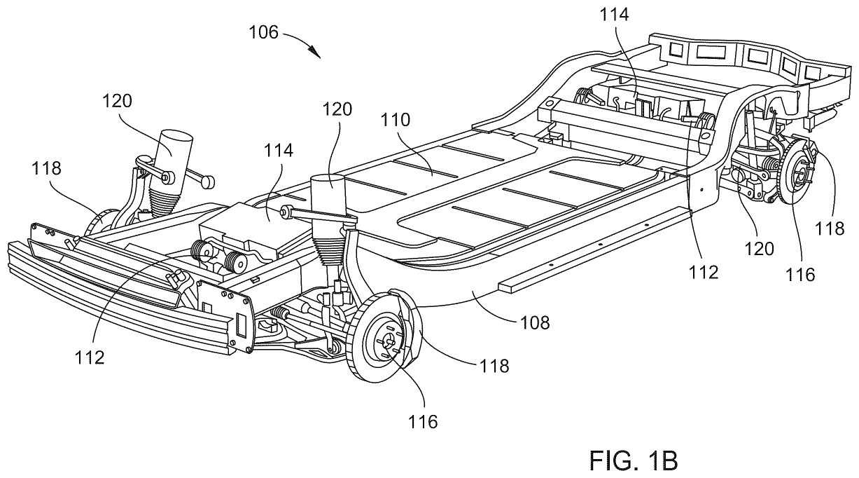

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more traction inverter systems 114, such as a traction inverter system 114 for each drive unit 112 or pair of drive units 112. The traction inverter systems 114 may include inverters configured to convert direct current (DC) from the battery 110 into alternating current (AC) supplied to the motors of the drive units 112. The traction inverter systems 114 further facilitate operation of the motors of the drive units as generators to provide regenerative braking. The traction inverter systems 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

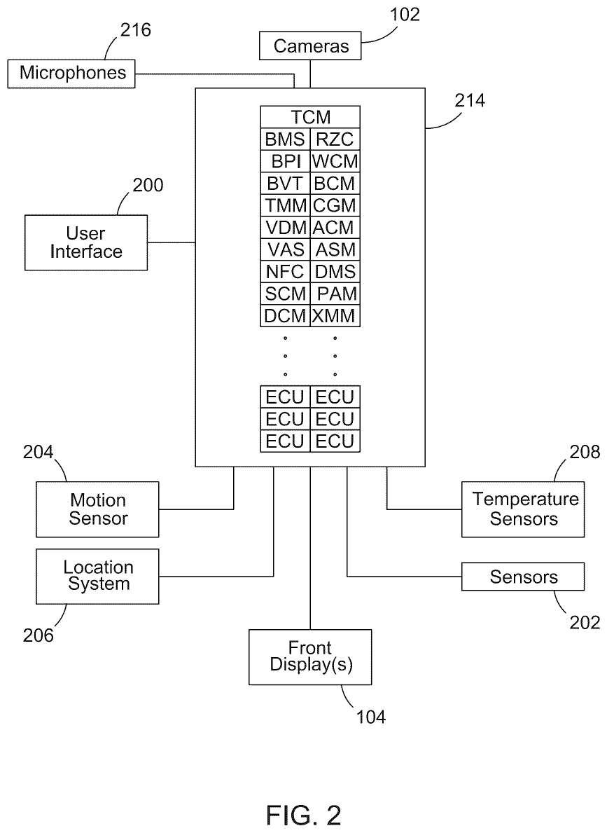

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of traction inverter systems 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the traction inverter systems 114.

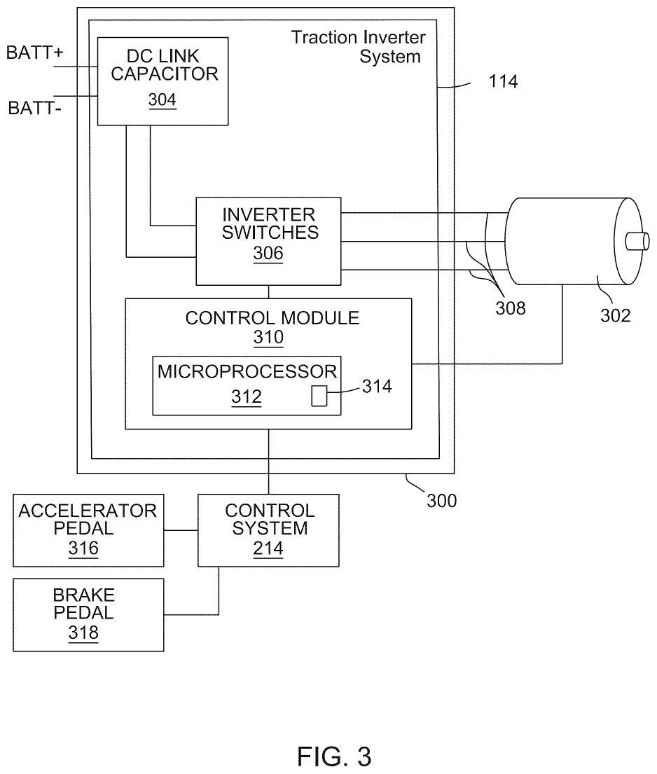

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3, the traction inverter system 114 may be contained within a housing 300, such as a housing made of aluminum or steel. The traction inverter system 114 may include a plurality of components configured to convert direct current (DC) from the battery 110 into alternating current (AC), such as three-phase AC, supplied to one or more motors 302 of the drive unit 112 including the traction inverter system 114.

The traction inverter system 114 may include a DC link capacitor 304 that receives power from the battery 110 and is coupled to the positive and negative terminals (Batt+, Batt−) of the battery 110. The DC link capacitor 304 functions to smooth current received from the battery 110 as part of the process by which the direct current from the battery 110 is converted to an approximately sinusoidal alternating current. The DC link capacitor 304 may further function to dampen any voltage spikes. The DC link capacitor 304 may be within the housing 300 or external to the housing 300.

The traction inverter system 114 may include inverter switches 306 coupled to the outputs of the DC link capacitor 304. The inverter switches 306 may include a plurality of switches that are selectively opened and closed to cause transmission of current to the outputs of the traction inverter system 114 at an appropriate frequency for driving the one or more motors 302. For example, the inverter switches 306 may output three-phase current over lines 308 connecting the inverter switches 306 to the motor 302. The opening and closing of the inverter switches 306 may be controlled by a control module 310. The control module 310 may include a printed circuit board with various electronic components configured to generate the control signals for the inverter switches 306. In some embodiments, the traction inverter system 114 drives two drive units 112 and include separate printed circuit boards for supplying current to the motors 302 of the separate drive units.

The control module 310 may further include a microprocessor 312 programmed to control operation of the control module 310 and therefore the inverter switches 306. The microprocessor 312 may be embodied as a silicon chip mounted to the printed circuit board of the control module 310. The microprocessor 312 may include a temperature sensor 314 mounted directly thereto.

The control module 310 may be coupled to the control system 214 and implement instructions from the control system 214 to control current supplied to the motor 302 and to cause the motor 302 to produce regenerative current. The control system 214 may generate such instructions as part of an automated driving algorithm (e.g., automatic cruise control), safety algorithm (e.g., traction control, stability control, automated emergency braking), or in response to inputs from a driver by way of an accelerator pedal 316 and/or brake pedal 318.

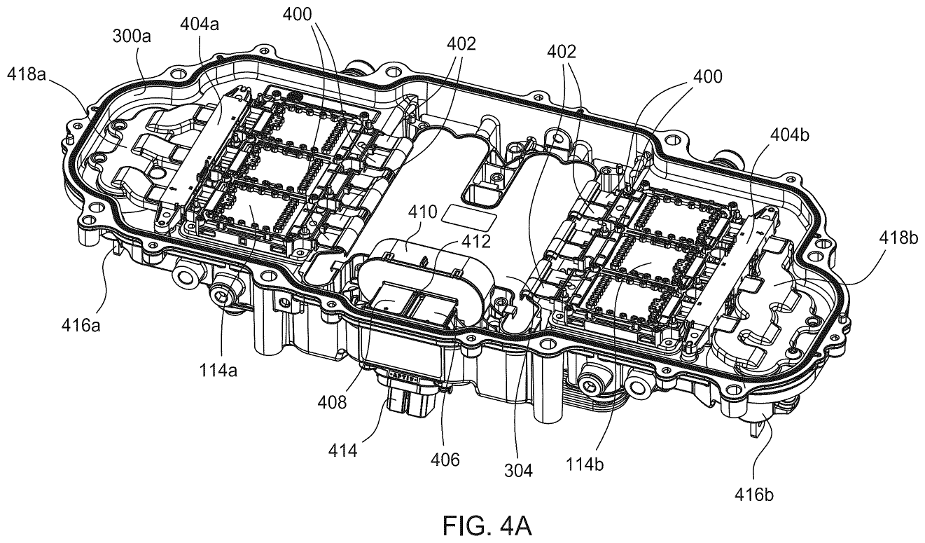

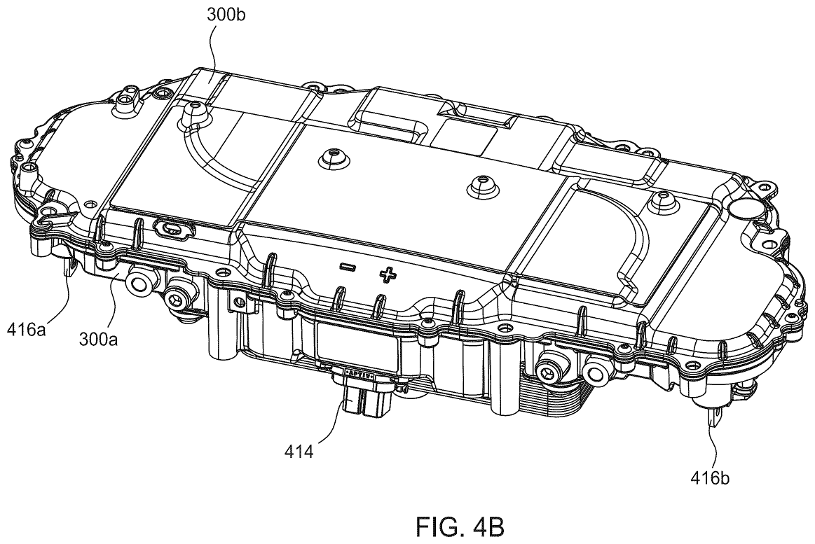

FIGS. 4A and 4B illustrate an example implementation of the traction inverter system 114, housing 300, and DC link capacitor 304. In the illustrated embodiment, the housing 300 includes a lower housing 300a and an upper housing 300b that together define a volume containing the DC link capacitor 304 and two sets of power electronics 114a, 114b. As used herein “power electronics 114a, 114b” refers to a subset of components of the traction inverter system 114 that are duplicated and used to drive separate motors 302. For example, the power electronics 114a, 114b may each include inverter switches 306. A single control module 310 may control the inverter switches 306 of each of the power electronics 114a, 114b or the power electronics may each include a control module 310 (including a microprocessor 312) configured to control the inverter switches 306 as described above. In the illustrated embodiment, a single DC link capacitor 304 is coupled to both power electronics 114a, 114b. However, separate DC link capacitors 304 may also be used. With the upper housing 300b secured to the lower housing 300a, the housing 300 may be sealed from ingress of air, water, or contaminants.

The power electronics 114a, 114b each connect to one or more positive output terminals 400 and one or more negative output terminals 402 of the DC link capacitor 304. For example, in the illustrated embodiment, the DC link capacitor 304 includes three positive output terminals 400 on each side interleaved with three negative output terminals 402 on each side. The positive and negative output terminals 400, 402 may be secured to the corresponding contacts (obscured by the positive and negative output terminals 400, 402 in FIG. 4A) on the power electronics 114a, 114b by means of screws, welds, or other fastening approach.

The DC link capacitor 304 further includes a positive input terminal 406 and a negative input terminal 408 coupled to Batt+ and Batt−, respectively. In some embodiments, the transmission of high-frequency signals to the power electronics 114a, 114b through the DC link capacitor 304 is inhibited by a DC choke 410. The DC choke 410 may be an inductive element made of wound wires, a laminate of conductive plates (e.g., metalized plastic), or other inductive structure. The DC choke 410 may define an opening 412 for receiving the positive input terminal 406 and the negative input terminal 408 with the wires, conductive laminate, or other inductive structures forming a loop around the opening 412. When the DC choke 410 and DC link capacitor 304 are mounted to the lower housing 300, the positive input terminal 406 and the negative input terminal 408 extend outwardly from the opening 412.

The positive input terminal 406 and the negative input terminal 408 may be electrically coupled to an input connector 414. The input connector 414 may provide an interface accessible from external to the housing 300 for connecting to a cable connected to the battery 110. The positive input terminal 406 and the negative input terminal 408 may secure to an input connector 414 using welds, screws, or other fastening approach.

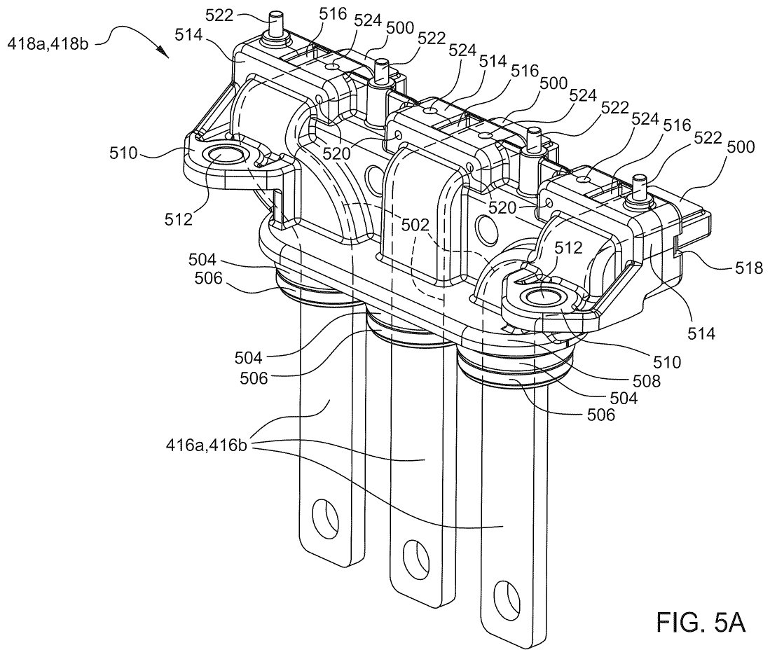

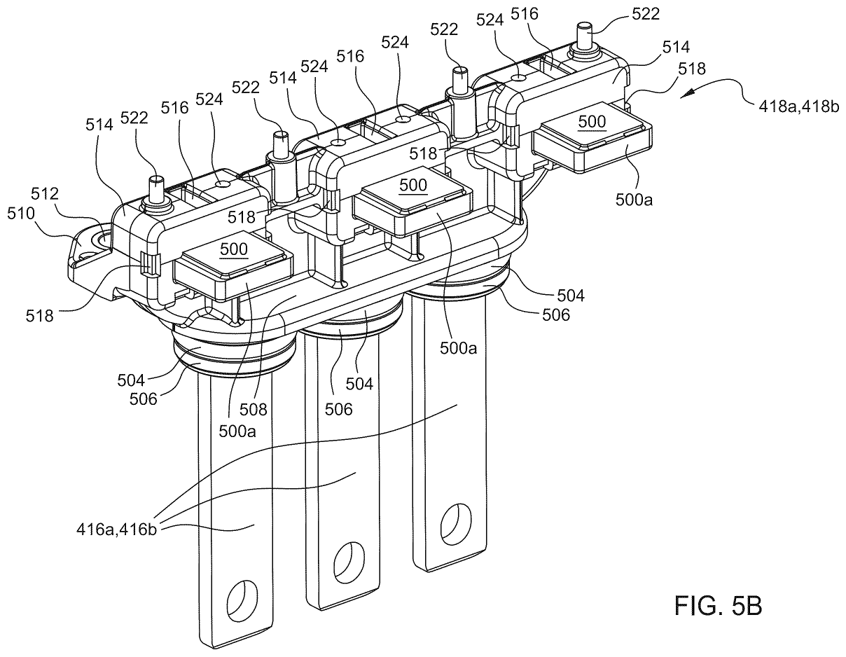

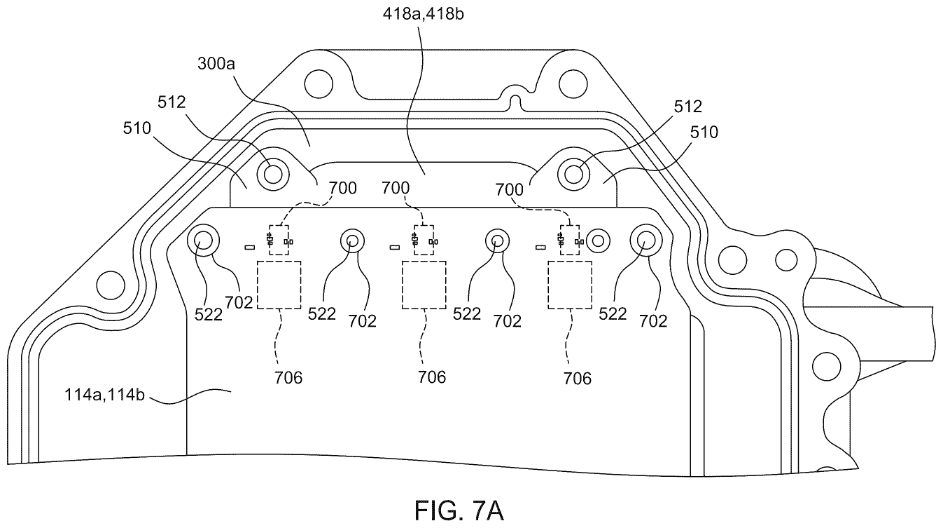

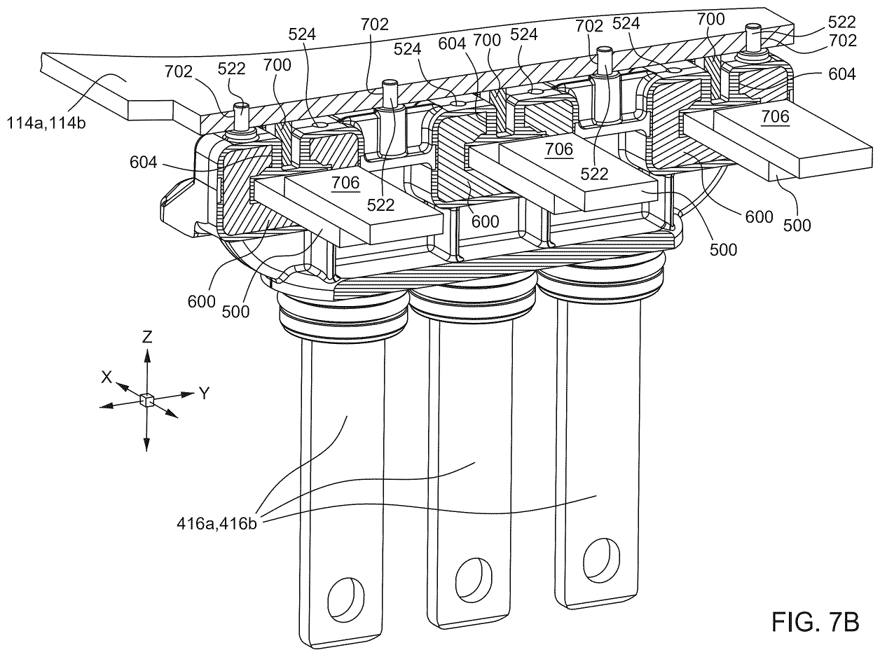

Referring to FIGS. 5A and 5B, while still referring to FIG. 4A, output terminals 416a, 416b supply current output by the power electronics 114a, 114b to the motor 302. The output terminals 416a, 416b may be embedded in a coupler body 418a, 418b, respectively. The coupler body 418a, 418b mounts the output terminals 416a, 416b to the housing, e.g., the lower housing 300a, such that the output terminals 416a, 416b are outside of the housing 300 and input terminals 500 (FIG. 5A) of the coupler body 418a are positioned within the housing 300 and in a position to establish electrical contact with output terminals of the power electronics 114a, 114b, respectively (see discussion of FIGS. 7A and 7B, below). The coupler body 418a, 418b may also create a seal with respect to the lower housing 300a.

The coupler body 418a, 418b may be formed of a plastic material providing electrical insulation and tolerating temperatures present in the housing 300 during operation. For example, the coupler body 418a, 418b may be formed of glass-filled nylon or other suitable material. The various features of the coupler body 418a, 418b described below may be formed by a molding step or a molding step followed by one or more other manufacturing steps.

As shown in FIG. 5A, each output terminal 416a, 416b and a respective one of the input terminals 500 may be formed from a single conductor, a portion of which is embedded in the coupler body 418a, 418b, as shown by the dotted representation 502 in FIG. 5A, leaving portions exposed to form the output terminals 416a, 416b and the input terminals 500. The single conductor may be bent such that the input terminals 500 are oriented substantially (e.g., within 5 degrees of) perpendicular to the output terminals 416a, 416b. However, this arrangement is exemplary only. As shown in FIG. 4B, the coupler body 418a, 418b may define platforms 500a for supporting, e.g., under, each terminal 500. The terminals 500 may be partially embedded in the platforms 500a. The coupler body 418a, 418b may be formed by overmolding a polymer over the single conductors.

The coupler body 418a, 418b may define one or more plugs 504 configured to seat within openings defined by the lower housing 300a. Each plug 504 may have a seal 506 extending therearound to prevent ingress of contaminants, such as an elastomeric O-ring. The coupler body 418a, 418b may define a platform 508 for resting on an interior surface of the housing 300, e.g., the lower housing 300a, when installed, the one or more plugs 504 protruding from a lower surface of the platform 508. In the illustrated embodiment, each output terminal 416a, 416b protrudes from a corresponding plug 504. In other embodiments, all output terminals 416a, 416b may protrude from a single plug 504.

The coupler body 418a, 418b may define one or more flanges 510 defining one or more openings 512 for receiving fasteners, e.g., screws, for securing the coupler body 418a, 418b to the lower housing 300a.

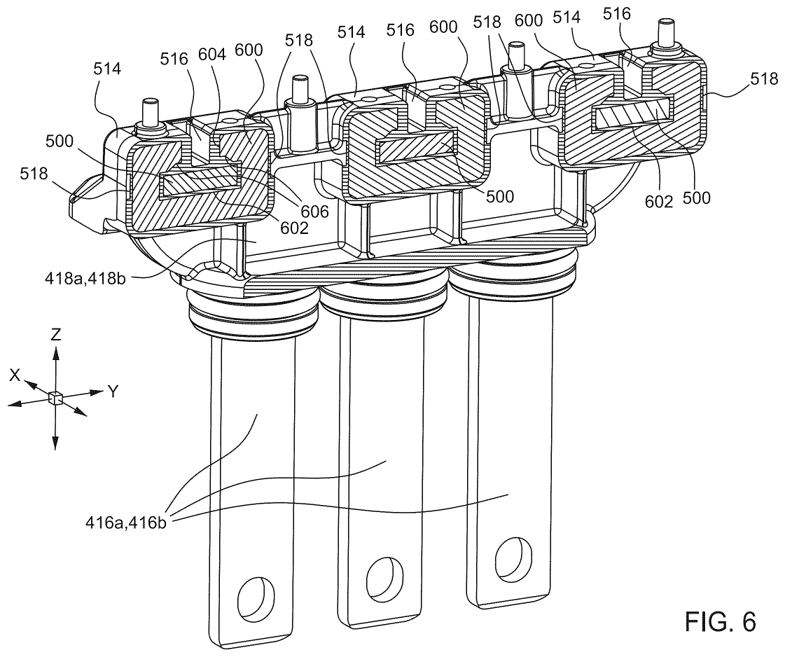

The coupler body 418a, 418b may include flux concentrator housings 514. The flux concentrator housings 514 each contain a flux concentrator surrounding one of the input terminals 500 for concentrating magnetic flux generated by current through the input terminal 500 within a cavity 516 defined by the flux concentrator housing 514. A Hall effect sensor positioned within the cavity may then sense magnetic fields generated by current flowing from an input terminal 500 to an output terminal 416a, 416b. The configuration of the flux concentrator and the Hall effect sensor are shown in FIGS. 6 and 7B, which are discussed in greater detail below.

As discussed in greater detail below with respect to FIG. 7A, the Hall effect sensors are mounted to a circuit board that is mounted near the coupler body 418a, 418b such that the Hall effect sensors extend into the cavities 516. Alignment of the Hall effect sensors with respect to the flux concentrators within the flux concentrator housings 514 may be facilitated by various features.

For example, the flux concentrators may be positioned relative to the input terminals 500 by various mold features when the coupler body 418a, 418b is formed around the flux concentrators. For example, one or more notches 518 are shown in each of the flux concentrator housings 514. Each notch 518 corresponds to a protrusion defined by a mold used to form the coupler body 418a, 418b and that holds the flux concentrator in position during molding of the coupler body 418a, 418b. Other features, such as recesses 520 may likewise correspond to pins protruding into a mold cavity and used to hold the flux concentrator in position during molding.

Alignment of the Hall effect sensors relative to the flux concentrator housings 514 may be facilitated by one or more protrusions 522 positioned on each flux concentrator housings 514 and/or between adjacent flux concentrator housings 514. Recesses 524 formed on the flux concentrator housings 514 may receive pins for positioning a flux concentrator during molding similarly to the notches 518. The recesses 524 may additionally receive pins to facilitate alignment with a circuit board, though this is not implemented in the illustrated embodiment. The Hall effect sensors may insert within the cavities 516 along an insertion direction such that the axes of symmetry (or corresponding insertion directions) of the protrusions 522 may be oriented substantially (e.g., within 0.5 degrees of) parallel to the insertion direction and to one another. For example, the cavities 516 may include portion having a constant cross section along a depth thereof, the insertion direction being defined as parallel to the axis along which this portion has constant cross section. Where the cavity 516 has sides conforming to a cuboid shape, the insertion direction may be defined as a line extending parallel to four edges of this cuboid shape that are parallel to one another.

FIG. 6 illustrates an example configuration of flux concentrators 600 that may be housed within the flux concentrator housings 514. A flux concentrator 600 is a split ring made of a high-permeability material that is configured to focus magnetic flux generated by current through the input terminal 500 into the cavity 516 defined by the flux concentrator housing 514 containing the flux concentrator 600. The concentrated flux will then be sensed by a Hall effect sensor. As used herein, high permeability material may include a material with a relative permeability (μ/μ₀) of at least 10, at least 100, at least 1000, or at least 10,000. The flux concentrator 600 may be formed of a monolithic piece of high permeability material or a laminate formed of multiple layers of high permeability material.

The flux concentrator 600 may be understood with respect to X, Y, and Z directions that are mutually perpendicular. Where the flux concentrator 600 is formed of multiple layers, the layers may be stacked along the X direction. The insertion direction through which the input terminal 500 passes through the flux concentrator 600 may be defined as parallel to the X direction. The portion of the input terminal 500 passing through the flux concentrator 600 may have a cross-sectional shape having sides conforming to a rectangle in the Y-Z plane. The flux concentrator 600 may define an opening 602 receiving the portion of the input terminal 500. The material forming the coupler body 418a, 418b may be positioned between the input terminal 500 and the rectangular opening 602. In some embodiments, the material forming the coupler body 418a, 418b may completely surround the flux concentrator 600 except for at the notches 518 and at the recesses 520, 524. In some embodiments, the material forming the coupler body 418a, 418b completely surrounds the concentrator 600 but is relatively thinner at the notches 518 and at the recesses 520, 524 (e.g., as shown in the cross-sectional view of FIG. 6).

The flux concentrator 600 extends around the input terminal 500 extending therethrough. The flux concentrator 600 forms a gap 604 extending through the flux concentrator 600 in the Y-Z plane to the opening 602, such that the gap 604 and rectangular opening 602 define a generally T-shaped opening. In the illustrated embodiment, the opening 602 is oblong with the longer dimension oriented in the Y direction and the shorter dimension oriented in the Z direction. The gap 604 may be substantially centered on the opening 602 along the longer dimension (Y direction in the illustrated embodiment), e.g., centered to within 10 percent of the width of the gap 604 in the Y direction. The cavity 516 may be defined by a portion of the material forming the coupler body 418a,418b that extends into the gap 604.

End portions 606 of the flux concentrator 600 extend inwardly toward one another along the Y direction and define the gap 604. The end portions 606 may be tapered in the Y-Z plane, e.g., decreasing in thickness in the Z direction with proximity to the gap 604 along the Y direction. The tapering of the end portions 606 may facilitate concentration of magnetic flux on the Hall effect sensor when positioned in the gap 604.

FIGS. 7A and 7B illustrate the use of the coupler body 418a, 418b with Hall effect sensors 700. The Hall effect sensors 700 may be mounted to the power electronics 114a, 114b, e.g., to a circuit board implementing part of the power electronics 114a, 114b. The power electronics 114a, 114b may define openings 702 receiving the protrusions 522 when the Hall effect sensors are positioned within the cavities 516.

The engagement of the protrusions 522 with the openings 702 may facilitate alignment of the Hall effect sensors with respect to the gaps 604 of the flux concentrators 600 in order to provide predictable estimates of current using outputs of the Hall effect sensors. Additional calibration steps may be performed following assembly to improve accuracy of current estimates.

As is apparent from the foregoing description, the coupler body 418a, 418b with the overmolded flux concentrators 600 greatly simplifies assembly with the power electronics 114a, 114b and the housing 300. In particular, individual placement of the flux concentrators 600 on the circuit board implementing the power electronics 114a, 114b is not required. Instead, the Hall effect sensors 700 may be lowered into the cavities 516 upon installation of the power electronics 114a, 114b.

In some embodiments, engagement of the input terminals 500 with output terminals 706 of the power electronics 114a, 114b likewise does not require an insertion step but rather lowering the power electronics 114a, 114b into the lower housing 300a such that the output terminals 706 engage the input terminals 500 as part of the same operation that lowers the hall effect sensors 700 into the cavities 516. The platforms 500a under the input terminals 500 may support the input terminals 500 and output terminals 706 during manufacture and/or during use.

The use of features for alignment with the power electronics 114a, 114b (protrusions 522) may be used to further facilitate achievement of required tolerances for the Hall effect sensors 700 relative to the flux concentrators 600 event though the Hall effect sensor 700 and flux concentrators 600 are mounted to different members.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. An apparatus comprising:
a plurality of conductors each having an input terminal and an output terminal;
a plurality of flux concentrators each having one conductor of the plurality of conductors passing therethrough and defining a gap; and
a coupler body molded over the plurality of conductors and the plurality of flux concentrators, the coupler body leaving the input terminal and the output terminal of each conductor of the plurality of conductors exposed, and the coupler body defining a plurality of cavities, each cavity extending into the gap of a flux concentrator of the plurality of flux concentrators for receiving a Hall effect sensor of a plurality of Hall effect sensors.

2. The apparatus of claim 1, wherein the coupler body includes a plurality of alignment features configured to receive mold features, the mold features maintaining positions of the plurality of flux concentrators relative to the plurality of flux concentrators and a mold during molding of the coupler body.

3. The apparatus of claim 2, wherein the plurality of alignment features include a plurality of recesses.

4. The apparatus of claim 1, wherein the coupler body defines a plurality of alignment features configured to align the coupler body with respect to a circuit board having the plurality of Hall effect sensors mounted thereto.

5. The apparatus of claim 4, wherein the plurality of alignment features include one or more protrusions configured to engage one or more recesses defined on the circuit board.

6. The apparatus of claim 4, wherein the plurality of alignment features include one or more recesses configured to engage one or more protrusions secured to the circuit board.

7. The apparatus of claim 4, wherein the plurality of alignment features include:
one or more protrusions configured to engage one or more recesses defined on the circuit board; and
one or more recesses configured to engage one or more protrusions secured to the circuit board.

8. The apparatus of claim 1, wherein the coupler body defines one or more plugs having one or more seals mounted thereto and configured to engage a housing, the output terminals of the plurality of conductors extending from the one or more plugs.

9. The apparatus of claim 8, wherein the coupler body defines a platform configured to engage an inner surface of the housing, the one or more plugs extending from the platform.

10. The apparatus of claim 1, wherein the input terminals of the plurality of conductors are oriented substantially perpendicular to the output terminals of the plurality of conductors.

11. The apparatus of claim 10, wherein the plurality of flux concentrators extend around portions of the input terminals of the plurality of conductors.

12. The apparatus of claim 1, wherein the plurality of flux concentrators comprise a material having a relative permeability of at least 100.

13. The apparatus of claim 12, wherein the plurality of flux concentrators comprise a laminate.

14. A method comprising:
mounting a coupler body to a housing, the coupler body comprising:
a plurality of flux concentrators each defining a gap; and
a plurality of conductors extending through the plurality of flux concentrators and including input terminals positioned within the housing and output terminals positioned outside of the housing; and
mounting a circuit board to the housing, the circuit board having a plurality of Hall effect sensors mounted thereto, each Hall effect sensor positioned within the gap of one flux concentrator of the plurality of flux concentrators when the circuit board is mounted to the housing.

15. The method of claim 14, further comprising:
engaging one or more first alignment features formed on the coupler body with one or more second alignment features on the circuit board.

16. The method of claim 15, wherein at least one of:
the one or more first alignment features include one or more protrusions, and the one or more second alignment features include one or more recesses; or
the one or more first alignment features include one or more recesses, and the one or more second alignment features include one or more protrusions.

17. The method of claim 14, wherein the coupler body defines one or more plugs having one or more seals mounted thereto and configured to engage the housing when mounted thereto, the output terminals extending through the one or more plugs.

18. The method of claim 14, wherein the input terminals are oriented substantially perpendicular to the output terminals and the plurality of flux concentrators extend around portions of the output terminals.

19. The method of claim 14, wherein the plurality of flux concentrators comprise a material having relative permeability of at least 100.

20. The method of claim 14, wherein the circuit board includes inverter switches of a traction inverter system.
